(19) United States
(12) Patent Application Publication
(10) Pub. No.: US 2020/0280379 A1
(43) Pub. Date: Sep. 3, 2020

(54) METHOD AND DEVICE FOR GENERATING A TRANSPORT STREAM, BROADCAST METHOD AND SITE, AND COMPUTER PROGRAM THEREFOR

(71) Applicant: ENENSYS TeamCast, Cesson-Sevigne (FR)

(72) Inventor: Stephane Lethimonier, Chevaigne (FR)

(21) Appl. No.: 16/625,305

(22) PCT Filed: Jun. 5, 2018
(86) PCT No.: PCT/EP2018/064787

§ 371 Date: Dec. 20, 2019

(30) Foreign Application Priority Data
Jun. 21, 2017 (FR) 1755637

(51) Int. Cl. H04H 20/18; H04L 12/18; H04H 20/67; H04W 4/06

(52) U.S. Cl. CPC H04H 20/18; H04W 4/06; H04H 20/67; H04L 12/1881

(57) ABSTRACT

A method for generating a transport stream intended to be distributed to a plurality of broadcast sites. The method includes: modulating a source signal, delivering a modulated signal; sampling the modulated signal, delivering a stream of complex samples; and framing the stream of complex samples, delivering the transport stream, wherein the framing includes: dividing the stream of complex samples into frames; inserting, in each frame, time information associated with the group of successive complex samples making up the frame for the time synchronization of the broadcasting sites.

### 1. FIELD OF THE INVENTION

The field of the invention is that of the distribution and broadcasting of information in a distribution and digital broadcasting network comprising at least one fixed reference site and a plurality of broadcasting sites. More specifically, the invention proposes a solution for the timing synchronization of the different broadcasting sites.

The term “fixed reference site” is understood to mean an entity enabling contents to be shaped and distributed in a distribution network. For example, such an entity is a head-end located in a content-creation studio.

The term “broadcasting site” is understood to mean an entity enabling the reception of contents distributed in the distribution network and their broadcasting especially towards individual receivers. For example, such an entity comprises at least one exciter. Classically, broadcasting sites are implanted in distinct geographical zones.

The invention can be applied more particularly but not exclusively to SFN (single frequency networks), irrespective of the broadcasting standard used:
DVB-Tor DVB-T2 (Digital VideoBroadcasting—Terrestrial);
T-DMB (Terrestrial Digital Multimedia Broadcasting);
ATSC (Advanced Television Systems Committee), especially ATSC 3.0;
ISDB-T (Integrated Services Digital Broadcasting—Terrestrial);
DAB (Digital Audio Broadcasting);
etc.

### 2. PRIOR ART

Here below, referring to FIG. 1, we present an example of a distribution network according to the ATSC 3.0 standard implementing a fixed reference site located for example in a content-creation studio, and a plurality of broadcasting sites SD1, SD2, SDN implanted in distinct geographical sites.

In the studio, the source data to be distributed 11 (source 1, source 2, etc., source i, for example of the data, audio and/or video services and other service types) provided by one or more service suppliers are pre-processed 12. For example, the source data are compressed and then formatted so that, at the broadcasting sites, each physical layer modulator can carry out a deterministic modulation. This pre-processing step can especially be implemented in a broadcast gateway of a network head-end.

In particular, the source data are encapsulated in baseband packets. These baseband packets, with signaling information and synchronization information obtained in taking account of a universal time reference (UTR), such as the GPS signal, are distributed to the broadcasting sites SD1, SD2, SDN by means of an STL (studio-to-transmitter link) interface. The baseband packets, with the signaling and synchronization information, can also be encapsulated in physical layer pipes before distribution.

In particular, STL packets, comprising baseband packets and signaling information, are conveyed in STL-TP transport packets on Ethernet, satellite or other links.

The source data are therefore managed in a centralized way in the studio, in order to create a unique transport signal, distributed to all the broadcasting sites, enabling especially a deterministic processing at the different broadcasting sites. The structure of such a transport signal is described in detail for example in the document “ATSC Candidate Standard: Scheduler/Studio to Transmitter Link”—Document 532-266r16—Sep. 30, 2016.

The distribution path 13 between the studio and the broadcasting sites SD1, SD2, SDN can be a satellite, microwave, fiber-optic or other type of link, possibly with transmission over IP.

Each broadcasting site SD1, SD2, SDN receives the transport signal, possibly delayed. It implements a processing enabling a re-synchronization of the complex samples obtained at output of the physical layer modulator of each broadcasting site, in taking account of the universal time reference, and implements a radiofrequency transmission of re-synchronized complex samples.

In particular, each broadcasting site SD1, SD2, SDN implements a modulator/exciter 141, 151, 161, delivering a radiofrequency signal and a power amplifier 142, 152, 162 of the radiofrequency signal. Each modulator/exciter 141, 151, 161 comprises especially:
a physical layer modulator integrating a timing synchronization delivering a stream of complex data, and
an exciter, integrating a quadratic modulator (also called an I/Q modulator), delivering a radiofrequency signal.

In addition, in the context of terrestrial digital broadcasting, SFN technology is classically used to improve the coverage of the territory/geographical zone and to mitigate shadow zones related to disturbances in the broadcast (mountains, hills, valleys, large buildings and the like). It also reduces the number of frequencies used, and therefore releases certain ranges of frequencies, and also optimizes transmission power.

For example, in the distribution network used in FIG. 1, the broadcasting site transmitters SD1, SD2, SDN send out a radiofrequency signal modulating a same frequency f1.

This SFN technology, which is highly efficient, implies that the broadcasting sites should have perfect time and frequency synchronization with one another. Thus, to synchronize the broadcasting sites belonging to a same SFN zone, a highly precise time and frequency reference must necessarily be provided to each broadcasting site.

### 3. SUMMARY OF THE INVENTION

In one embodiment, the invention proposes a method for generating a transport stream intended for distribution to a plurality of broadcasting sites comprising the following steps:
modulating a source signal, delivering a modulated signal, sampling the modulated signal, delivering complex samples,
framing the complex samples, delivering the transport stream,
   the step for framing comprising:
dividing the complex samples among at least one frame,
inserting, into each frame, at least one timestamp for the timing synchronization of the broadcasting sites.

The invention in this embodiment thus proposes to move, at the fixed reference site, a part of the modulation processing conventionally implemented in the physical layer modulators of each broadcasting site.

More specifically, this embodiment of the invention proposes the transport, in the transport stream distributed by the fixed reference site and to broadcasting sites, of complex samples also called I and Q samples or I/Q samples.

Moving away a part of the modulation processing to the network head-end reduces the complexity and therefore the cost of the exciters of each broadcasting site.

In particular, in order to ensure a timing synchronization of the broadcasting sites, at least one timestamp is associated with a group of complex samples, also called a frame. The insertion of such a timestamp into a frame makes it possible especially to ensure SFN operation of the broadcasting sites receiving the transport stream. In addition, the insertion of the timestamp into the frame of complex samples enables a synchronous distribution of the timestamp and of the complex samples.

The frequency synchronization of the broadcasting sites, for its part, can be done classically, using a reliable reference signal such as the GPS.

According to one particular embodiment, the timestamp inserted into a frame corresponds to the instant of sending of the first complex sample of the frame by the transmitters of the broadcasting sites. According to another embodiment, the timestamp inserted into a frame corresponds to the instant when a signal leaves the SFN adapter of the different broadcasting sites. In another embodiment, the invention relates to a piece of equipment for generating a corresponding transport stream.

The technique for generating a transport stream according to the invention can therefore be implemented in various ways, among others in hardware and/or software form.

Another embodiment of the invention relates to a method for broadcasting data, implemented in a broadcasting site, comprising the following steps:
reception of a transport stream, comprising at least one frame carrying complex samples, representing a source signal, and at least one timestamp for the timing synchronization of the broadcasting site with at least one remote broadcasting site;
detection, in the transport stream, of the first complex sample of a frame;
extraction, from the transport stream, of the complex samples of the frame;
detection, in the transport stream, of the timestamp associated with the frame;
sending of the first complex sample of the frame at the instant defined by the timestamp.

Such a method, implemented at the broadcasting sites, is especially intended for reception of a transport stream generated by the method for generating a transport stream described here above.

In particular, the timestamp carried by the transport stream can be used by the broadcasting site to determine the instant of sending of the radiofrequency signals or the instant when a signal leaves the SFN adapter signal of the broadcasting sites, and thus ensure the timing synchronization of the radiofrequency signals broadcast by the different broadcasting sites receiving the same transport stream.

In another embodiment, the invention relates to a corresponding broadcasting site.

The broadcasting technique according to the invention can therefore be implemented in various ways, especially in hardware and/or software form.

For example, at least one step of the technique for generating a transport or broadcasting stream according to one embodiment of the invention can be implemented:
on a reprogrammable computation machine (a computer, a DSP (digital signal processor) for example, a microcontroller etc.) executing a program comprising a sequence of instructions,
a dedicated computation machine (for example a set of logic gates such as an FPGA (Field Programmable Gate Array) or an ASIC (Application-Specific Integrated Circuit), or any other hardware module).

In particular, the computer program can use any programming language whatsoever and can take the form of source code, object code or intermediate code between source code and object code such as in a partially compiled form or in any other desirable form whatsoever.

One embodiment of the invention is therefore also aimed at protecting one or more computer programs comprising instructions adapted to the implementing of the methods of generation of a transport or data broadcasting stream as described here above when this program or these programs are executed by a processor, as well as at least one information carrier readable by a computer comprising instructions of at least one computer program as mentioned here above.

One embodiment of the invention also relates to a broadcasting system comprising a device for the generation of a transport stream and at least two broadcasting sites as described here above, wherein the broadcasting sites are configured to send out a radiofrequency signal on a same frequency.

### 4. LIST OF FIGURES

Other features and advantages of the invention shall appear more clearly from the following description of a particular embodiment, given by way of a simple illustratory and non-exhaustive example, and from the appended drawings of which:

FIG. 1, described with reference to the prior art, presents a block diagram of a distribution network according to the ATSC 3.0 standard;

FIG. 2 illustrates a distribution network according to one embodiment of the invention;

FIG. 3 illustrates a first example of a transport packet according to one embodiment of the invention;

FIG. 4 illustrates a second example of a transport packet according to one embodiment of the invention;

FIGS. 5 and 6 respectively present the simplified structure of a fixed reference site and a broadcasting site according to one embodiment of the invention.

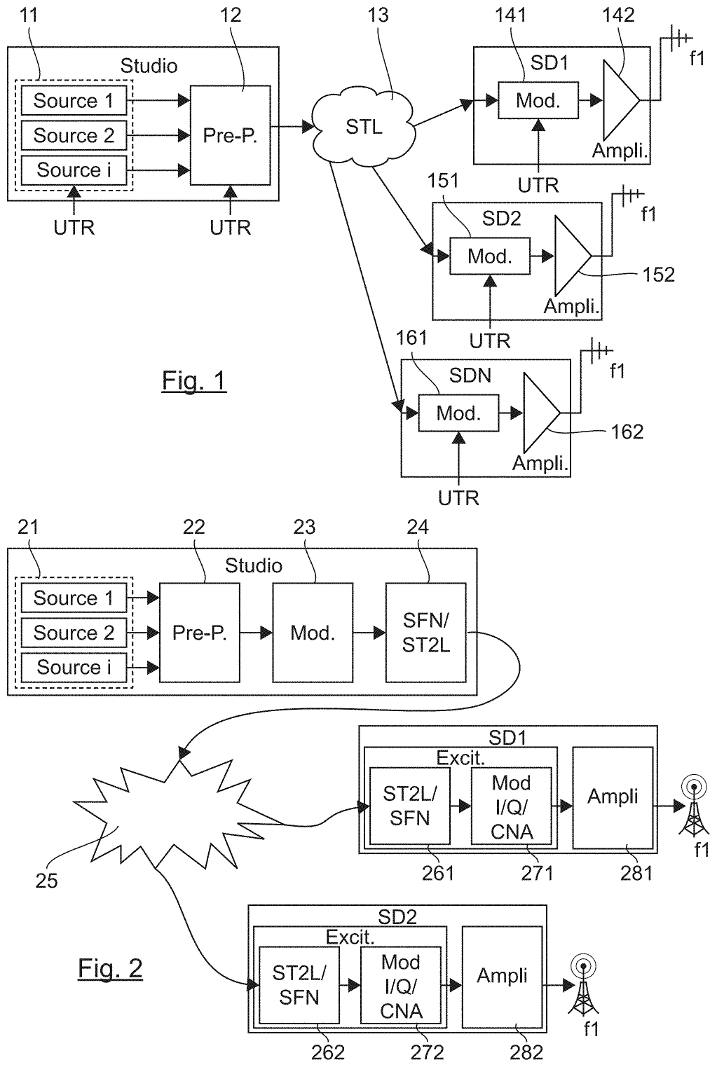

### 5. DESCRIPTION OF EMBODIMENTS OF THE INVENTION

The invention is set in the context of a distribution and digital broadcasting network comprising at least one fixed reference site and a plurality of broadcasting sites, according to which a part of the processing of the physical layer modulation is done at the reference site. We thus obtain a stream of complex samples (also called I and Q samples or I/Q samples) intended for distribution to a plurality of broadcasting sites.

More specifically, the general principle of the invention relies on the insertion of at least one piece of timing synchronization information associated with a group of complex samples obtained at output from the physical layer modulation (implemented in the reference site).

FIG. 2 illustrates an example of a distribution network according to one embodiment of the invention, based on the ATSC 3.0 standard. Naturally, the invention is not limited to this broadcasting standard and can be implemented with any digital broadcasting standard, authorizing especially an SFN operation by the broadcasting sites.

The distribution network illustrated in FIG. 2 comprises a fixed reference site located for example in a content-creation studio and a plurality of broadcasting sites, for example two reference sites SDN and SD2 laid out in distinct geographical sites and belonging to a same SFN zone.

5.1 Method Implemented on the Fixed Reference Site Side

### A) General Principle

Such a fixed reference site, also called a device for the generation of a transport stream, implements the method for generating a transport stream according to one embodiment of the invention.

Thus, at the studio, the source data 21 to be distributed (source 1, source 2, etc., source i, for example of the data, audio and/or video services and other types of services), provided by one or more service providers, can be pre-processed 22. For example, the source data are encoded, multiplexed and ordered in an encoding/multiplexing/scheduling block or encoder/multiplexer/scheduler. The pre-processing step 22 can especially be implemented in a broadcast gateway.

The source data, possibly pre-processed, are then modulated 23 in a physical layer modulation block, delivering a modulated signal. Such a physical layer modulation block implements especially a conversion of the possibly pre-processed source data from the frequency domain into the time domain, for example by means of an inverse fast Fourier transform.

The complex samples (I and Q samples) of the sampled modulated signal are framed 24 in an SFN/ST2L adaptation block, also called an SFN/ST2L adapter or ST2L interface, generating a unique transport stream intended for distribution to the different broadcasting sites SD1, SD2 by means of a distribution network 25 (satellite link, microwaves, fiber-optic, etc., possibly with IP or ASI transmission).

More specifically, the framing of the complex samples comprises:
the dividing of the complex samples among at least one frame,
the insertion, into each frame, of at least one timestamp for the timing synchronization of the broadcasting sites.

In other words, the ST2L interface enables the transport of the complex samples generated by a physical layer modulator located at the studio (for example an ATSC 3.0 modulator) towards a set of exciters of the broadcasting site, with the information needed for the timing synchronization of these complex samples in order to obtain an SFN functioning for the broadcasting sites. In particular, since the conversion from the frequency domain to the time domain is implemented in the physical layer modulator located in the studio, each broadcasting site directly obtains complex samples (I and Q samples), thus removing the need to carry out a conversion from the frequency domain to the time domain at each broadcasting site.

Thus, the SFN adaptation is carried out by sub-dividing the stream of complex samples into “frames” (or groups of successive complex samples) and by associating with each frame at least one timestamp. Such a timestamp corresponds for example to the time at which this frame must be broadcast by each of the broadcasting sites or, again, the instant at which the first complex sample of the frame is sent or, according to another example, the instant at which a signal leaves the SFN adaptor of the broadcasting sites.

Possibly, the complex samples can be compressed before being framed.

According to a first example, the complex samples are divided among frames corresponding to classic physical frames of a signal according to the ATSC 3.0 standard, also called ATSC 3.0 frames. In this case, it is easy, on the broadcast site side, to detect the start of a frame of complex samples.

According to a second example, the complex samples are divided among “virtual” frames of arbitrary length.

The length of the frames can be fixed (i.e. all the frames have the same length). In this case, the length of the frames can depend on the sampling frequency of the modulated signal in order to obtain a whole number of complex samples per frame. For example, if the sampling frequency corresponds to the frequency of the system clock according to the ATSC 3.0 standard, i.e. 6.912 MHz, the modulated signal is sampled at 6,912 Msps (mega samples per second). It is therefore possible to divide the complex samples among one-second frames (each comprising 6,912,000 complex samples)—corresponding to a whole number of system clock periods, or among half-second frames (each comprising 3,456,000 complex samples), etc.

The length of the frames can also be variable. In this case, an indicator and/or a pointer can be used to mark the start, the end or the length of a frame.

In another particular embodiment, a frame is fragmented to distribute its complex samples among one or more transport packets. These transport packets are, for example denoted as “ST2L packets”.

The transport packet(s) or directly the complex samples can be possibly encapsulated in one or more IP packets, especially in the payload of the IP packets. The timestamp associated with a group of complex samples can be inserted into the header of one of the IP encapsulation layers, for example the timestamp can be inserted into the field “Timestamp” of the RTP header. The length of the transport packets can be fixed (i.e. all the transport packets have the same length). In this case, advantageously, a length is chosen making it possible to have a whole number of complex samples per transport packet, and a whole number of transport packets per frame.

The length of the transport packets can also be variable. In this case, an indicator and/or a pointer can be used to mark the start, the end, or the length of a transport packet.

For example, such transport packets are MPEG-TS type packets, i.e. having the same structure as the MPEG-TS packets. In other words, the ST2L packets are MPEG-TS type packets. Thus, each transport packet contains 188 bytes. The encapsulation of the complex samples in transport packets enables especially the reutilization of the modules conventionally used to transport or process MPEG-TS packets, such as the modules implementing an error-correction encoding. The use of 188-byte transport packets ensures especially a compatibility of the proposed technique with the SMPTE-2022 standard.

In particular, a transport packet comprises a field reserved for the timestamp (for example, on 3 bytes) and a field carrying complex samples (for example on 180 bytes).

According to one particular embodiment making it possible to avoid the transport of timestamp in all the transport packets of a frame, the field reserved for the timestamp of the transport packet that carries the first complex sample of the frame carries the timestamp, and the field reserved for the timestamp of the other transport packets is empty or non-existent.

Thus, if a frame comprises only one transport packet, the field reserved for the timestamp carries the timestamp.

For example, the structure of at least one transport packet is equivalent to the structure of an MPEG-TS packet and comprises:
a header comprising:
   a synchronization field,
   an error indicator indicating whether the complex samples carried by the transport packet are reliable,
   a start indicator indicating whether the transport packet carries the first complex sample of a frame,
a payload comprising:
   a field reserved for the timestamp,
   a field carrying the transport packet number, and
   a field carrying the complex samples.

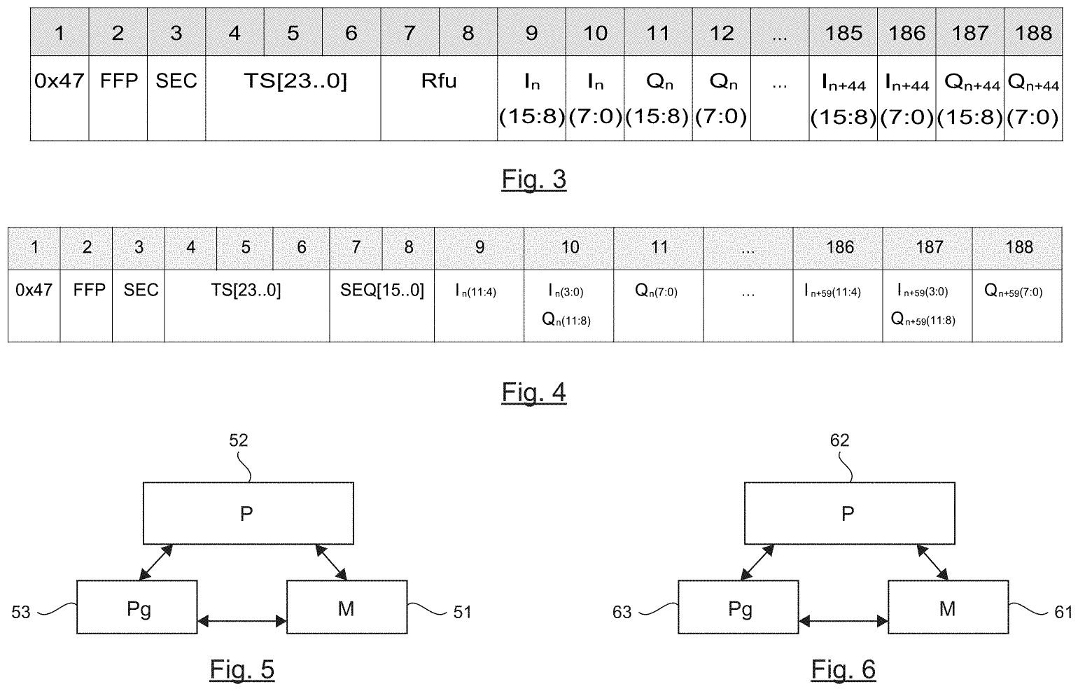

Here below, referring to FIGS. 3 and 4, we present two examples of the framing of the complex samples.

In these two examples, the frames are deemed to comprise transport packets presenting a structure equivalent to that of an MPEG-TS packet, each transport packet bearing 188 bytes. According to these two examples, it is therefore considered that complex samples are encapsulated in MPEG-TS type packets.

### B) First Example

FIG. 3 illustrates the structure of a transport packet carrying complex samples according to a first example.

According to this first example, the complex samples are mapped on to 180 bytes among the 188 bytes of the transport packet. Each (I or Q) component of a complex sample is encoded on 16 bits. Each (I/Q) complex sample is therefore encoded on 4 bytes (2x16 bits) and each transport packet can carry 45 complex samples on 180 bytes.

More specifically, the first byte, byte 1, is a synchronization byte (0x47).

The byte 2, denoted as FFP (Frame Flag and Pointer) comprises:
an error indicator, on one bit, for example FFP(7), indicating whether the complex samples carried by the transport packet are “clean” or “reliable” (i.e. if the broadcasting site can broadcast them). For example, if FFP(7)=1, the complex samples carried by this transport packet will not be taken into account by the different broadcasting sites (exciter output “mute”) because it is considered to be corrupt, and if FFP(7)=0, the complex samples carried by this transport packet will be taken into account by the different broadcasting sites because they are considered to be reliable;
a start indicator, on one bit, for example FFP(6), indicating whether the transport packet carries the start of a frame, i.e. the first complex sample of a frame. For example, if FFP(6)=0, this transport packet does not carry the first sample of a frame, and if FFP(6)=1, this transport packet carries the first sample of a frame;
a pointer from 0 to 44, for example FFP(5 . . . 0), indicating the position of the first complex sample of a frame, among the 45 complex samples of the transport packet. This pointer is used if FFP(6)=1 (which means that this transport packet carries the start of a frame). For example, a pointer value equal to 0 indicates that the first complex sample of the transport packet is the first complex sample of a frame, and a pointer value equal to 44 (0x2C) indicates that the last complex sample of the transport packet is the first sample of a frame.

The use of such a pointer therefore dissociates the frames carrying the transport packets. In other words, the complex samples of a transport packet can belong to different frames, and the number of transport packets in a frame is not necessarily a whole number. Such a pointer thus demarcates a frame, if the number of transport packets in a frame is not a whole number.

The byte 3, denoted as SEC, carries a part of the timestamp, corresponding to the integer or absolute part of the timestamp. In particular, if the timestamp corresponds to a sending instant, this byte indicates the number of the second (0 to 59) at which the first sample of the frame should be sent at broadcasting sites. This field is used if FFP(6)=1 for this transport packet (which means that this transport packet carries the start of a frame). If not, this field is empty or reserved for the transport of another type of information.

The bytes 4 to 6, denoted as TS[23 . . . 0], carry a part of the timestamp, corresponding to the fractional or relative part of the timestamp. In particular, if the timestamp corresponds to an instant of sending, these bytes indicate the fraction of a second (0 to 0x6977FF) within a period of the system clock (for example at the frequency 6.912 MHz according to the ATSC 3.0 standard) at which the first sample of a frame should be sent at the broadcasting sites. This field is used if FFP(6)=1 for this transport packet (which means that this transport packet carries the start of a frame). If not, this field is empty or reserved for the transport of another type of information.

The use of these two fields SEC and TS[23 . . . 0] therefore makes it possible to obtain, at the broadcasting sites, a very precise piece of information relating to the sending instant. The timestamp based for example on a clock system at 6.912 MHz for the fractional or relative part enables a simple and precise computation at the SFN adaptor of the broadcasting sites (references 261, 262 in FIG. 2). This fractional or relative part is reset at zero at each synchronization pulse (for example one pulse per second or one pps, coming from a reference signal, for example of the GPS type). The integer or absolute part (SEC) is for example extracted from the UTC time.

It can be noted that the distribution of this absolute part to the broadcasting sites is not obligatory, as presented here below with reference to the second embodiment.

The bytes 7 to 8 referenced Rfu (reserved for future use) are left vacant in this first example.

The bytes 9 to 188 are used for the transport of complex samples, each complex sample being carried by 4 bytes (2x16 bits). For example, the bytes 9 and 10 carry the I component of the complex sample n and the bytes 11 and 12 carry the Q component of the complex sample n. The bytes 13 and 14 carry the I component of the complex sample n+1 and the bytes 15 and 16 carry the Q component of the complex sample n+1. The bytes 185 and 186 carry the I component of the complex sample n+44, and the bytes 187 and 188 carry the Q component of the complex sample n+44.

If the sampling rate is 6.912 Msps, the useful bitrate of the transport stream thus obtained (useful network bitrate) at the physical layer is of the order of 6.912×32, giving about 221 Mbps and the total bitrate of the transport stream at the physical layer (raw bitrate) is of the order of 6.912×32×188/180, giving about 231 Mbps.

Such a bitrate is compatible with a distribution of the transport stream on an Ethernet link.

Thus, the transport packets can be, for example, put in groups of seven, and the groups of seven transport packets can be encapsulated in an RTP packet to transmit these RTP packets on an Ethernet interface. To this end RTP packets can be encapsulated in IP packets, as described in the SMPTE-2022 standard. The set of the protocols used for the distribution of the data is IQ/TS/RTP/UDP/IP/ETH.

With respect to RTP encapsulation, it can be noted that the timestamp classically present in the header of the RTP packets is not necessary, since a timestamp for the synchronization of the broadcasting sites is already present in the transport packets.

The sequence number conventionally provided in the header of the RTP packets can be used to detect a de-scheduling or a loss of RTP packets.

A forward error correction module (FEC), for example according to the SMPTE-2022-2 standard, can be implemented to protect the distribution over the IP network. As a variant, such an FEC module is not implemented. There is therefore neither a rebuilding of the lost RTP packets nor a rescheduling on the broadcasting site side. If RTP packets are lost (or de-scheduled), they can be replaced by padding, i.e. by null complex samples at the broadcasting sites.

With regard to the UDP/IP encapsulation, it can be noted that the destination multicast IP address and the UDP destination port number can be configured by the user.

In particular, at the IP encapsulation level, it is possible to use a mechanism to verify a checksum for the detection, on the broadcasting site side, of an error in the content and to eliminate a transport packet considered to be corrupted/or replace the complex samples carried by this transport packet by padding at the broadcasting sites.

For example, the chosen encapsulation generates an IP stream at 238 Mbps for a total bitrate of 231 Mbps (MPEG-TS bitrate) and a useful bitrate of 221 Mbps, for a sampling rate at 6.912 Msps (IQ bitrate).

It can be noted, according to this example, that the total bitrate obtained does not allow for direct distribution of the transport packets carrying the complex samples on an ASI (Asynchronous Serial Interface).

Here below we therefore present a second example enabling a direct distribution of the transport packets on an ASI interface.

### C) Second Example

FIG. 4 illustrates the structure of a transport packet carrying complex samples according to a second example.

According to this second example, the complex samples are mapped on to 180 bytes, among the 188 bytes of the transport packet. Each (I or Q) component of a complex sample is encoded on 12 bits. Each complex sample (I/Q) is therefore encoded on 3 bytes (2x12 bits) and each transport packet can carry 60 complex samples on 180 bytes. Indeed, in reducing the number of bits used to encode a complex sample, it is possible to increase the number of complex samples per transport packet, for a same length of transport packet.

More specifically, the structure of a transport packet according to this second example is the following:
the byte 1 is a synchronization byte (0x47)—as in the case of the first example;
the byte 2, denoted FFP, comprises—as in the case of the first example:
   an error indicator, on one bit, for example FFP(7), indicating whether the complex samples carried by the transport packet are “clean” or “reliable” (i.e. whether the broadcasting site can broadcast them);
   a start indicator, on one bit, for example FFP(6), indicating whether the transport packet carries the start of a frame, i.e. the first complex sample of a frame.

According to this second example, the FFP(5 . . . 0) bits of the byte 2 can be empty. As a variant, the FFP(5 . . . 0) bits of the byte 2 carry a pointer from 0 to 59 indicating the position of the first complex sample of a frame, among the 60 complex samples of the transport packet, as in the case of the first example.

It is possible that the byte 3, denoted as SEC, will not be used according to this second example.

The bytes 4 to 6 denoted as TS[23 . . . 0] carry a part of the timestamp corresponding to the fractional or relative part of the timestamp. In particular, if the timestamp corresponds to a sending instant, these bytes indicate the fraction of a second (0 to 0x6977FF) within a period of the clock system (for example at the frequency of 6.912 MHz according to the ATSC 3.0 standard) at which the first sample of a frame would have to be sent at the broadcasting sites. This field is used if FFP(6)=1 for this transport packet (this means that this transport packet carries the start of a frame). If not, this field is empty or reserved for the transport of another type of information.

In the particular case of frames having a duration of one second and a system clock at the frequency of 6.912 MHz, the fractional or relative part of the timestamp is identical for each frame (the field TS[23 . . . 0] indicating the fraction of a second within one period of the system clock, modulo one second).

As a variant, to prevent the distribution of a field TS[23 . . . 0] empty if FFP(6)=0, it is possible to encode a complex sample on the three bytes 4 to 6. According to this variant, for the complex samples of a frame, the transport packet carrying the first complex sample of the frame (FFP(6)=1) can carry the timestamp on the bytes 4 to 6, and 60 complex samples on the bytes 9 to 188. The other transport packets (FFP(6)=0) can carry 61 complex samples, one complex sample on the bytes 4 to 6 and 60 complex samples on the bytes 9 to 188. According to this variant, the transport packets therefore do not all carry the same number of complex samples.

According to this second example, to improve the reliability/security of the distributed complex samples, a counter is added to the bytes 7 and 8. More specifically, the bytes 7 and 8, denoted SEQ[15 . . . 0] carry the transport packet number in the sequence of transport packets, encoded on 16 bits (i.e. modulo 65536 the number of the transport packet is encoded on two bytes). Such a field makes it possible to count the transport packets and can be used for the detection, at the broadcasting sites, of a break in sequence (de-scheduling in the transport packets, loss of a transport packet, etc.).

The bytes 9 to 188 are used for the transport of the complex samples, each complex sample being borne by 3 bytes (2x12 bits). For example, the bytes 9 to 11 bear the I component and the Q component of the complex sample n. The bytes 12 to 14 bear the I component and the Q component of the complex sample n+1. The bytes 186 to 188 bear the I component and the Q component of the complex sample n+59.

If we consider a sampling rate of 6.912 Msps, the complex samples can be distributed among frames having a length of 1 second, giving 6,912,000 complex samples per frame. Thus, the 6,912,000 complex samples of a frame can be encapsulated in 115,200 transport packets, each bearing 60 complex samples. In this way, the number of complex samples per transport packet is a whole number and the number of transport packets per frame is a whole number. For example, only the first transport packet carries an FFP(6) start indicator equal to 1 (which means that this first transport packet carries the first sample of the frame) and the timestamp for the synchronization of the broadcasting sites (field TS[23 . . . 00]). In this case, it is not necessary to manage a pointer indicating the position of the first complex sample of a frame, since the first complex sample of a frame corresponds to the first complex sample of the first transport packet (which is equivalent to FFP[5 . . . 0]=0).

In particular, the presence of an error indicator and of the field SEQ[15 . . . 0] enables the distribution of a transport stream that is robust against errors.

If the sampling rate is 6.912 Msps, the useful net bitrate of the transport stream thus obtained at the physical layer is of the order of 6.912×24, giving about 166 Mbps, and the raw bitrate of the transport stream in the physical layer is of the order of 6.912×24×188/180, giving about 173.3 Mbps.

Such a bitrate is compatible with a distribution of the transport stream on ASI interface.

Such a bitrate is also compatible with the distribution of the transport stream on an Ethernet link. In this case, an RTP/UDP/IP encapsulation can be implemented as described with reference to the first example or in the SMPTE-2022 standard. The implementing of an FEC module to protect the distribution over the IP network is optional, inasmuch as a piece of information on the order of the transport packets is already present in the SEQ[15 . . . 00] field of each transport packet (transport packet number in the sequence).

5.2 Method Implemented on the Broadcasting Site Side

Returning to FIG. 2, the transport stream thus generated is distributed among different broadcasting sites SD1, SD2 by a means of the distribution network 25.

Each broadcasting site can implement the data broadcasting method according to one embodiment of the invention. In particular, the post-processing related to the amplification of the power of the radiofrequency signal for the broadcasting continues to be managed by the broadcasting sites.

Each broadcasting site SD1, SD2 therefore receives the transport stream and implements a processing operation enabling the re-synchronization of the complex samples at each broadcasting site. Indeed, each broadcasting site receives a delayed version of the transport stream because of the latency between the fixed reference site and the broadcasting site and/or because of jitter. Now, in the particular case of SFN broadcasting, each broadcasting site must send out a multiplex at the same instant and at the same frequency. It is therefore necessary for each broadcasting site to rebuild and re-synchronize the complex samples carried by the transport stream before broadcasting.

The data broadcasting method implements the following steps at each broadcasting site of an SFN zone:
reception of the transport stream as described here above, comprising at least one frame carrying complex samples, representing a source signal and at least one timestamp for the timing synchronization of the broadcasting site with at least one remote broadcasting site;
detection, in the transport stream, of the first complex sample of a frame;
extraction, from the transport stream, of the complex samples of the frame;
detection, in the transport stream, of the timestamp associated with the frame;
sending of the first complex sample of the frame at the instant defined by the timestamp.

For example, each broadcasting site SD1, SD2 comprises an ST2L adaptation/SFN synchronization block 261, 262, implementing the steps of reception of the transport stream, detection of the first complex sample of a frame and of the timestamp associated with the frame, and extraction of the set of complex samples from the frame.

For example, as and when they are extracted, the complex samples are stored in a buffer memory. Thus, at the instant of sending defined in the timestamp, the first complex sample of the frame can be broadcast. Such a buffer memory makes it possible especially to absorb the latency and/or the jitter of the different broadcasting sites. The writing of the complex samples to buffer memory can be varyingly rapid, depending on the broadcasting site. By contrast, the reading of the complex samples is implemented at a regular rhythm, common to the different broadcasting sites, depending on the system clock.

Each broadcasting site SD1, SD2 also implements a quadratic modulator (also called a I/Q modulator) 271, 272, delivering a radiofrequency signal, and a power amplifier 281, 282 of the radiofrequency signal.

For example, the ST2L adaptation/SFN synchronization block 261 (and 262 respectively) and the quadratic modulator 271 (and 272 respectively) present at the broadcasting site SD1 (and SD2 respectively) belong to an exciter of the broadcasting site SD1 (and SD2 respectively).

In particular, the quadratic modulator 271, 272 presents in each broadcasting site implements an in-quadrature modulation of a transmission carrier, with the complex samples extracted from the transport stream and a digital/analog conversion DAC. The sending step thus makes it possible to send the transmission carrier modulated by the first complex sample at the instant defined by the timestamp.

If we take the context of the examples described here above, according to which the samples of a frame are considered to be divided among transport packets having a structure equivalent to that of an MPEG-TS packet, the detection of the first complex sample of a frame implements the extraction of the transport packets associated with this frame, and the detection of a start indicator, for example FFP(6).

The transport packet bearing the indicator FFP(6)=1 carries the first sample of this frame. For example, the pointer FFP(5 . . . 0) indicates the position of the first complex sample of the frame. It is thus possible to detect the first complex sample of a frame and extract the other complex samples of this frame (following samples). It is also possible to detect and extract the timestamp associated with this frame in the field TS[23 . . . 00] and as the case may be in the SEC field.

From the timestamp extracted from a first frame, it is possible to temporally synchronize the stream of complex samples in accordance with the value of this timestamp, for example by sending out, at each broadcasting site, the first complex sample of the first frame at the instant defined by the timestamp. It is then possible to verify that the timing synchronization is always correct, through the pieces of timestamp extracted from the following transport packets or from the following frames.

In particular, if the error indicator FFP(7) associated with a transport packet is equal to 1, the complex samples borne by this transport packet will not be taken into account by the different broadcasting sites, and are possibly replaced by padding (complex samples of zero value).

Similarly, if an error in the number of transport packets is detected through the SEQ field [15 . . . 00] of the transport packets (de-scheduling of the transport packets or loss of one or more transport packets), the broadcasting site (especially the exciter) can reschedule the transport packets or replace the complex samples of the lost transport packets with padding (complex samples with zero value) or decide not to broadcast the data in order to protect the broadcast site.

In particular, these different fields FFP(7) and SEQ [15 . . . 00] enable the signaling to the broadcasting site, especially to the exciter, of a problem in the transport packet and makes it possible to inform the amplifier of this problem so that it does not seek to amplify the power of the corrupted or non-received complex samples.

5.3 Devices

Finally, referring to FIGS. 5 and 6, we present the simplified structure of a device for generating a transport stream and a broadcasting site according to one embodiment of the invention.

As illustrated in FIG. 5, a device for generating a transport stream according to one embodiment of the invention comprises a memory 51 (comprising for example a buffer memory) and a processing unit 52 (equipped for example with at least one processor, FPGA or DSP) driven or pre-programmed by an application or a computer program 53 implementing the method for generating a transport stream according to one embodiment of the invention.

At initialization, the code instructions of the computer program 53 are for example loaded into a RAM and then executed by a processing unit 52. The processing unit 52 inputs at least one content to be distributed (source 1, source 2, source i). The processing unit 52 implements the steps of the method of generation described here above, according to the instructions of the computer program 53, to generate a transport stream comprising at least one frame carrying complex samples, representative of a source signal, and at least one timestamp for the timing synchronization of the broadcasting sites.

To this end, according to one embodiment, the processing unit 52 is configured to:
modulate a source signal, delivering a modulated signal,
sample the modulated signal, delivering complex samples, and
frame the complex samples by:
   dividing the complex samples among at least one frame,
   inserting, in each frame, at least one timestamp for the timing synchronization of the broadcasting sites.

As illustrated in FIG. 6, a broadcasting site according to one particular embodiment of the invention comprises a memory 61 (comprising for example a buffer memory) and a processing unit 62 (equipped for example with at least one processor, FPGA or DSP) driven or pre-programmed by an application or a computer program 63 implementing the data-broadcasting method according to one embodiment of the invention.

At initialization, the code instructions of the computer program 63 are for example loaded into a RAM memory and then executed by a processing unit 62. The processing unit 62 inputs a transport stream. The processing stream 62 implements the steps of the method of broadcasting data described here above, according to the instructions of the computer program 63 to extract and re-synchronize the complex samples so as to ensure the timing synchronization of the broadcasting sites.

To this end, according to one embodiment, the processing unit 62 is configured to:
receive a transport stream, comprising at least one frame carrying complex samples, representative of a source signal, and at least one timestamp for the timing synchronization of the broadcasting site with at least one remote broadcasting site;
detect, in the transport stream, the first complex sample of a frame;
extract, from the transport stream, the complex samples of the frame;
detect, in the transport stream, the timestamp associated with the frame; and
send out the first complex sample of the frame at the instant defined by the timestamp.

5.4 Variants

Here above, we have described an example of implementation of the invention according to the ATSC 3.0 standard. Naturally, other broadcasting standards can be envisaged. The number of complex samples per frame or per transport packet can thus vary, for example according to the frequency of the system clock.

Similarly, we have described an implementation of the method for generating a transport stream in a fixed reference site, and the implementing of the data-broadcasting method at a broadcasting site. Naturally, certain steps (for example the computation and the storage of complex samples) can be implemented in the “cloud”, by one or more remote servers communicating for example by the Internet.

The implementing of certain operations in the “cloud” especially simplifies the devices of the distribution network, especially the implementing of the physical layer modulation. We thus have a more flexible architecture of the distribution network.

It can also be noted that, in both examples described for the structure of a transport packet, we have used the bytes 2 to 4 to facilitate the detection of the frames and optimize the generation of a transport stream. However, in one particular embodiment of the invention, these bytes 2 to 4 can be released to ensure the compatibility of the transport packets with the MPEG-TS standard.

1. A method for generating a transport stream for distribution to a plurality of broadcasting sites, wherein the method comprises the following acts performed by a transport stream generating device:
modulating a source signal, delivering a modulated signal,
sampling said modulated signal, delivering a stream of complex samples,
framing said stream of complex samples, delivering said transport stream, wherein the framing comprises:
subdividing said stream of complex samples into frames,
inserting, into each frame, a timestamp for timing synchronization of said broadcasting sites, associated with the complex samples composing said frame.

2. The method according to claim 1, wherein said timestamp inserted into a frame corresponds to an instant of sending of a first complex sample of said frame by transmitters of said broadcasting sites.

3. The method according to the claim 1, wherein a length of each frame depends on the frequency of sampling of said modulated signal.

4. The method according to claim 1, wherein said complex samples of each frame are distributed in transport packets.

5. The method according to claim 4, wherein each transport packet comprises a field reserved for the timestamp and a field carrying complex samples of said frame.

6. The method according to claim 5 wherein, for a frame:
the field reserved for the timestamp of the transport packet that carries the first complex sample of the frame carries said timestamp, and
the field reserved for the timestamp of the other transport packets is empty.

7. The method according to claim 5, wherein at least one of said transport packets also comprises:
a header comprising:
a synchronization field,
an error indicator indicating whether the complex samples carried by the transport packet are reliable,
a start indicator indicating whether the transport packet carries the first complex sample of a frame,
a payload comprising:
said field reserved for said timestamp,
a field carrying the number of the transport packet,
said field carrying said complex samples.

8. The method according to claim 5, wherein at least one of said transport packets further comprises a pointer indicating a position of the first complex sample of the frame in the transport packet.

9. The method according to claim 4, wherein said transport packets are MPEG-TS type packets.

10. A method for broadcasting data, implemented in a broadcasting site, wherein the method comprises:
a phase of adaptation comprising the following acts:
receiving a transport stream, comprising frames each carrying successive complex samples, representative of a source signal, and a timestamp for timing synchronization of said broadcasting site with at least one remote broadcasting site, associated with the successive complex samples composing said frame;
detecting, in said transport stream, a first complex sample of one of said frames;
extracting, from said transport stream, the complex samples of said frame;
detecting, in said transport stream, said timestamp associated with said frame;
and a phase of sending said first complex sample of said frame at an instant defined by said timestamp.

11. The method according to claim 10, further comprising performing an in-quadrature modulation of a transmission carrier, with said complex samples extracted from said transport stream,
and wherein the phase of sending sends the transmission carrier modulated by said first complex sample at the instant defined by said timestamp.

12. A device for generating a transport stream intended for distribution to a plurality of broadcasting sites, comprising:
at least one processor operationally coupled to a memory and configured to:
modulate a source signal, delivering a modulated signal,
sample the modulated signal, delivering a stream of complex samples, and
frame said stream of complex samples, delivering said transport stream, including:
sub-dividing the stream of complex samples into frames,
inserting, into each frame, at least one timestamp for timing synchronization of said broadcasting sites, associated with the complex samples composing said frame.

13. A data-broadcasting site comprising:
at least one processor operationally coupled to a memory and configured to:
receive a transport stream, comprising frames each carrying successive complex samples, representative of a source signal, and a timestamp for timing synchronization of said broadcasting site with at least one remote broadcasting site, associated with the successive complex samples composing said frame;
detect in said transport stream, a first complex sample of one of said frames;
extract, from said transport stream, the complex samples of said frame;
detect, in said transport stream, said timestamp associated with said frame; and
send said first complex sample of said frame at an instant defined by said timestamp.

14. A non-transitory computer-readable medium comprising a computer program stored thereon, comprising instructions for executing a method for generating a transport stream for distribution to a plurality of broadcasting sites, when this program is executed by a processor of a transport stream generating device, wherein the instructions configure the transport stream generating device to:
modulate a source signal, delivering a modulated signal,
sample said modulated signal, delivering a stream of complex samples,
frame said stream of complex samples, delivering said transport stream, wherein the framing comprises:
subdividing said stream of complex samples into frames,
inserting, into each frame, a timestamp for timing synchronization of said broadcasting sites, associated with the complex samples composing said frame.
